(19) United States
(12) Patent Application Publication
(10) Pub. No.: US 2025/0215161 A1
(43) Pub. Date: Jul. 3, 2025

(54) THERMOPLASTIC COMPOSITIONS, METHODS OF THEIR MANUFACTURE, AND ARTICLES THEREOF

(71) Applicant: SHPP GLOBAL TECHNOLOGIES B.V., Bergen op Zoom (NL)

(72) Inventors: Roland Sebastian Assink, Middelburg (NL); Erik Schwartz, Nijmegen (NL); Mark Adrianus Johannes Van Der Mee, Etten Leur (NL)

(21) Appl. No.: 18/842,632

(22) PCT Filed: Mar. 3, 2023
(86) PCT No.: PCT/IB2023/052016

§ 371 Date: Aug. 29, 2024

(30) Foreign Application Priority Data
Mar. 4, 2022 (EP) 22160219.6

(51) Int. Cl. C08G 77/448; C08L 83/10

(52) U.S. Cl. CPC C08G 77/448; C08L 83/10

(57) ABSTRACT

A thermoplastic composition comprising: 75 to 98 wt % of a poly(carbonate-siloxane-arylate) and optionally a poly(carbonate-arylate); a poly(carbonate-siloxane) having 30-70 wt % siloxane content, preferably 0.5 to less than 4 wt %, based on the total weight of the poly(carbonate-siloxane) present in an amount effective to provide 0.5 to wt % siloxane units based on the total weight of the composition; a flame retardant; and optionally, 0.1 to wt % of an additive composition, wherein each amount is based on the total weight of the poly(carbonate-siloxane-arylate), optional poly(carbonate-arylate), poly(carbonate-siloxane), flame retardant, and optional additive composition, which does not exceed 100%.

### BACKGROUND

This disclosure relates to thermoplastic compositions, and in particular to thermoplastic compositions that may be used to make interior components for aircrafts, methods of manufacture, and articles thereof.

Materials for use in constructing interior aircraft components must meet stringent flammability safety requirements. Particular requirements include smoke density, flame spread, and heat release values. In the United States, Federal Aviation Regulation (FAR) Part 25.853 sets forth the airworthiness standards for aircraft compartment interiors. The safety standards for aircraft and transportation systems used in the United States include a smoke density test specified in FAR 25.5 Appendix F, Part V Amdt 25-116. Flammability requirements include the “60 second test” specified in FAR 25.853 (a) Appendix F, Part I, (a), 1, (i) and the heat release rate standard (referred to as the OSU 65/65 standard) described in FAR F25.4 (FAR Section 25, Appendix F, Part IV), or the French flame retardant tests such as, NF-P-92-504 (flame spread) or NF-P-92-505 (drip test). In another example, the aircraft manufacturer Airbus has smoke density and other safety requirements set forth in ABD0031. In addition, because disinfectants and cleaning products are used on aircraft compartment interiors, it is desirable to provide thermoplastic compositions with improved chemical resistance.

There accordingly remains a need in the art for thermoplastic compositions with chemical resistance, while also meeting the flammability safety requirements for interior aircraft components. It would be a further advantage if the thermoplastic compositions had good aesthetics and/or antimicrobial resistance.

### SUMMARY

A thermoplastic composition comprises: 70 to 98 wt % of a poly(carbonate-siloxane-arylate) and optionally a poly(carbonate-arylate); a poly(carbonate-siloxane) having 30-70 wt % siloxane content, based on the total weight of the poly(carbonate-siloxane) present in an amount effective to provide 0.5 to 10 wt %, preferably 0.5 to less than 4 wt % siloxane units based on the total weight of the composition; a flame retardant; and optionally, 0.1 to 10 wt % of an additive composition, optionally, 0.1 to 15 wt % of an antimicrobial agent, wherein each amount is based on the total weight of the poly(carbonate-siloxane-arylate), optional poly(carbonate-arylate), poly(carbonate-siloxane), flame retardant, optional antimicrobial agent, and optional additive composition, which does not exceed 100%.

An article comprising the thermoplastic composition is selected from a molded article, a thermoformed article, an extruded film, an extruded sheet, a foamed article, a layer of a multi-layer article, a substrate for a coated article, and a substrate for a metallized article, preferably wherein the article is an aircraft interior component.

A method of manufacture of an article comprises additively manufacturing the article using a powder or filament comprising the thermoplastic composition.

### DETAILED DESCRIPTION

The inventors hereof have discovered thermoplastic compositions having improved impact resistance and good chemical resistance against typical aircraft interior cleaning agents, while maintaining smoke and heat release properties. The thermoplastic compositions include the combination of a poly(carbonate-siloxane-arylate), a poly(carbonate-siloxane) having a siloxane content of 30-70 wt %, and a flame retardant. The thermoplastic compositions may advantageously be used to make aircraft components, in particular, thin-wall aircraft components meeting or exceeding governmental and aircraft manufacturer flame safety requirements.

The individual components of the thermoplastic compositions are described in more detail below.

The thermoplastic compositions include poly(carbonate ester) s, in particular, a poly(carbonate-siloxane-arylate) and optionally, a poly(carbonate-arylate). Both the poly(carbonate-siloxane-arylate) and the poly(carbonate-arylate) include aromatic carbonate repeating units and aromatic ester (i.e., arylate) repeating units. The aromatic carbonate units are of formula (1).

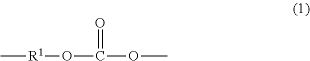

R¹ may be derived from an aromatic dihydroxy compound of the formula HO—R¹—OH, in particular of formula (2) or formula (6)

HO-A¹-Y¹-A²-OH (2)

wherein each of A¹ and A² is a monocyclic divalent aromatic group and Y¹ is a single bond or a bridging group having one or more atoms that separate A¹ from A². In an aspect, one atom separates A¹ from A². Preferably, each R¹ may be derived from a bisphenol of formula (3)

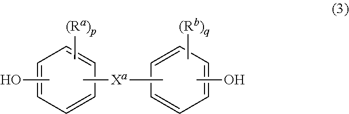

wherein R^{a} and R^{b} are each independently a halogen, C₁₋₁₂ alkoxy, or C₁₋₁₂ alkyl, and p and q are each independently integers of 0 to 4. It will be understood that when p or q is less than 4, the valence of each carbon of the ring is filled by hydrogen. Also in formula (3), X^{a} is a bridging group connecting the two hydroxy-substituted aromatic groups, where the bridging group and the hydroxy substituent of each C₆ arylene group are disposed ortho, meta, or para (preferably para) to each other on the C₆ arylene group. In an aspect, the bridging group X^{a} is single bond, —O—, —S—, —S(O)—, —S(O)₂—, —C(O)—, or a C₁₋₆₀ organic group. The organic bridging group may be cyclic or acyclic, aromatic or non-aromatic, and may further comprise heteroatoms such as halogens, oxygen, nitrogen, sulfur, silicon, or phosphorous. The C₁₋₆₀ organic group may be disposed such that the C₆ arylene groups connected thereto are each connected to a common alkylidene carbon or to different carbons of the C₁₋₆₀ organic bridging group. In an aspect, p and q is each 1, and R^{a} and R^{b} are each a C₁₋₃ alkyl group, preferably methyl, disposed meta to the hydroxy group on each arylene group.

Useful dihydroxy compounds of the formula HO—R¹—OH include aromatic dihydroxy compounds of formula (6)

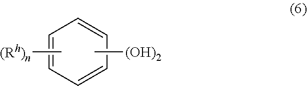

wherein each Rh is independently a halogen atom, C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4. The halogen is usually bromine.

Some illustrative examples of specific dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl) sulfide, bis(4-hydroxyphenyl) sulfoxide, bis(4-hydroxyphenyl) sulfone, 9,9-bis(4-hydroxyphenyl) fluorine, 2,7-dihydroxypyrene, 6,6′-dihydroxy-3,3,3′,3′-tetramethylspiro(bis) indane (“spirobiindane bisphenol”), 3,3-bis(4-hydroxyphenyl) phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or a combination thereof.

Specific examples of bisphenol compounds of formula (3) include 1,1-bis(4-hydroxyphenyl)methane, 1,1-bis(4-hydroxyphenyl)ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl)propane, 1,1-bis(4-hydroxyphenyl) n-butane, 2,2-bis(4-hydroxy-2-methylphenyl) propane, and 1,1-bis(4-hydroxy-t-butylphenyl) propane. A combination may also be used

In addition to recurring carbonate units of formula (1), the poly(carbonate-siloxane-arylate) and the optional poly(carbonate-arylate) include repeating ester units of formula (7)

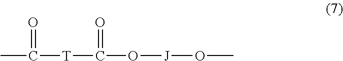

wherein J is a divalent group derived from an aromatic dihydroxy compound (including a reactive derivative thereof), such as a bisphenol of formula (2), e.g., bisphenol A; and T is a divalent group derived from an aromatic dicarboxylic acid (including a reactive derivative thereof), preferably isophthalic or terephthalic acid wherein the weight ratio of isophthalic acid to terephthalic acid is 91:9 to 2:98. Copolyesters containing a combination of different T or J groups may be used. The polyester units may be branched or linear.

In an aspect, J is a C₂₋₃₀ alkylene group having a straight chain, branched chain, or cyclic (including polycyclic) structure, for example ethylene, n-propylene, i-propylene, 1,4-butylene, 1,4-cyclohexylene, or 1,4-methylenecyclohexane. In another aspect, J is derived from a bisphenol of formula (3), e.g., bisphenol A. In another aspect, J is derived from an aromatic dihydroxy compound of formula (6), e.g, resorcinol.

Aromatic dicarboxylic acids that may be used to prepare the polyester units include isophthalic or terephthalic acid, 1,2-di(p-carboxyphenyl) ethane, 4,4′-dicarboxydiphenyl ether, 4,4′-bisbenzoic acid, or a combination thereof. Acids containing fused rings may also be present, such as in 1,4-, 1,5-, or 2,6-naphthalenedicarboxylic acids. Specific dicarboxylic acids include terephthalic acid, isophthalic acid, naphthalene dicarboxylic acid, 1,4-cyclohexane dicarboxylic acid, or a combination thereof. A specific dicarboxylic acid comprises a combination of isophthalic acid and terephthalic acid wherein the weight ratio of isophthalic acid to terephthalic acid is 91:9 to 2:98.

Specific ester units include ethylene terephthalate, n-propylene terephthalate, n-butylene terephthalate, 1,4-cyclohexanedimethylene terephthalate, and ester units derived from isophthalic acid, terephthalic acid, and resorcinol (ITR)). The molar ratio of ester units to carbonate units in the copolymers may vary broadly, for example 1:99 to 99:1, preferably 10:90 to 90:10, more preferably 25:75 to 75:25, or 2:98 to 15:85, depending on the desired properties of the final composition. Specific poly(ester-carbonate) s are those including bisphenol A carbonate units and isophthalate-terephthalate-bisphenol A ester units, also commonly referred to as poly(carbonate-ester) s and poly(phthalate-carbonate) s, depending on the molar ratio of carbonate units and ester units.

In a specific aspect, the poly(carbonate-siloxane-arylate) and/or the poly(carbonate-arylate) include a poly(bisphenol A carbonate)-co-(bisphenol A-phthalate-ester) of formula (8a)

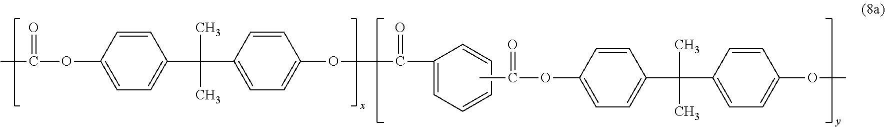

wherein y and x represent the wt % of arylate-bisphenol A ester units and bisphenol A carbonate units, respectively. Generally, the units are present as blocks. In an aspect, the wt % of ester units y to carbonate units x in the copolymers is 50:50 to 99:1, or 55:45 to 90:10, or 75:25 to 95:5. Copolymers of formula (8a) comprising 35 to 45 wt % of carbonate units and 55 to 65 wt % of ester units, wherein the ester units have a molar ratio of isophthalate to terephthalate of 45:55 to 55:45 are often referred to as poly(carbonate-ester) s (PCE). Copolymers comprising 15 to 25 wt % of carbonate units and 75 to 85 wt % of ester units having a molar ratio of isophthalate to terephthalate from 98:2 to 88:12 are often referred to as poly(phthalate-carbonate) s.

In another aspect, the poly(carbonate-siloxane-arylate) and the poly(carbonate-arylate) each independently include carbonate units (1) and repeating monoarylate ester units of formula (7b)

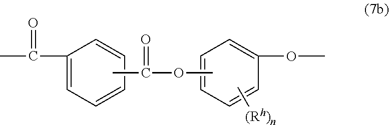

wherein each Rh is independently a halogen atom, a C₁₋₁₀ hydrocarbyl such as a C₁₋₁₀ alkyl group, a halogen-substituted C₁₋₁₀ alkyl group, a C₆₋₁₀ aryl group, or a halogen-substituted C₆₋₁₀ aryl group, and n is 0 to 4. Preferably, each Rh is independently a C₁₋₄ alkyl, and n is 0 to 3, 0 to 1, or 0. These poly(carbonate-co-monoarylate ester) s include units of formula (8b)

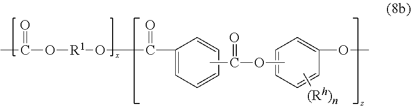

wherein R¹ is as defined in formula (1) and Rh and n are as defined in formula (7b), and the mole ratio of carbonate units x to ester units z is from 99:1 to 1:99, or from 98:2 to 2:98, or from 90:10 to 10:90. In an aspect the mole ratio of x:z is from 50:50 to 99:1, or from 1:99 to 50:50.

Preferably, the monoarylate ester unit (7b) is derived from the reaction of a combination of isophthalic and terephthalic diacids (or a reactive derivative thereof) with resorcinol (or a reactive derivative thereof) to provide isophthalate/terephthalate-resorcinol (“ITR” ester units) of formula (7c).

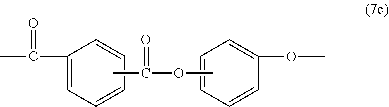

In an aspect, the ITR ester units are present in the polycarbonate copolymer in an amount greater than or equal to 95 mol %, preferably greater than or equal to 99 mol %, and still more preferably greater than or equal to 99.5 mol %, based on the total moles of ester units in the copolymer. Such (isophthalate/terephthalate-resorcinol)-carbonate copolymers (“ITR-PC”) may possess many desired features, including toughness, transparency, and weatherability. ITR-PC copolymers may also have desirable thermal flow properties. In addition, ITR-PC copolymers may be readily manufactured on a commercial scale using interfacial polymerization techniques, which allow synthetic flexibility and composition specificity in the synthesis of the ITR-PC copolymers.

A specific example of a poly(carbonate-co-monoarylate ester) is a poly(bisphenol A carbonate-co-isophthalate-terephthalate-resorcinol ester) of formula (8c)

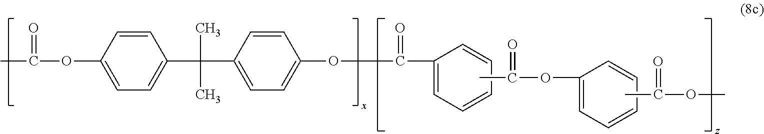

wherein the mole ratio of x:z is or from 98:2 to 2:98, or from 90:10 to 10:90. In an aspect the mole ratio of x:z is from 50:50 to 99:1, or from 1:99 to 50:50. The ITR ester units may be present in the poly(bisphenol A carbonate-co-isophthalate-terephthalate-resorcinol ester) in an amount greater than or equal to 95 mol %, preferably greater than or equal to 99 mol %, and still more preferably greater than or equal to 99.5 mol %, based on the total moles of ester units in the copolymer. Other carbonate units, other ester units, or a combination thereof may be present, in a total amount of 1 to 20 mole %, based on the total moles of units in the copolymers, for example resorcinol carbonate units of formula (20) and bisphenol ester units of formula (7a):

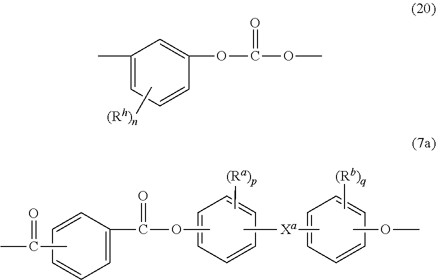

wherein, in the foregoing formulae, Rh is each independently a C₁₋₁₀ hydrocarbon group, n is 0 to 4, R^{a} and R^{b} are each independently a C₁₋₁₂ alkyl, p and q are each independently integers of 0 to 4, and X^{a} is a single bond, —O—, —S—, —S(O)—, —S(O)₂—, —C(O)—, or a C₁₋₁₃ alkylidene of formula —C(R^{c})(R^{d})— wherein R^{c} and R^{d} are each independently hydrogen or C₁₋₁₂ alkyl, or a group of the formula —C(═R^{e})— wherein R^{e} is a divalent C₁₋₁₂ hydrocarbon group. The bisphenol ester units may be bisphenol A phthalate ester units of the formula

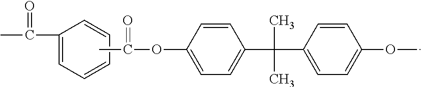

In an aspect, poly(bisphenol A carbonate-co-isophthalate-terephthalate-resorcinol ester) (8c) comprises 1 to 90 mol % of bisphenol A carbonate units, 10-99 mol % of isophthalic acid-terephthalic acid-resorcinol ester units, and optionally 1 to 60 mol % of resorcinol carbonate units, isophthalic acid-terephthalic acid-bisphenol A phthalate ester units, or a combination thereof. In another aspect, poly(bisphenol A carbonate-co-isophthalate-terephthalate-resorcinol ester) (8c) comprises 10-20 mol % of bisphenol A carbonate units, 20-98 mol % of isophthalic acid-terephthalic acid-resorcinol ester units, and optionally 1-60 mol % of resorcinol carbonate units, isophthalic acid-terephthalic acid-bisphenol A phthalate ester units, or a combination thereof.

The polycarbonate copolymers comprising arylate ester units are generally prepared from polyester blocks. The polyester blocks may also be prepared by interfacial polymerization. Rather than utilizing the dicarboxylic acid or diol per se, the reactive derivatives of the acid or diol, such as the corresponding acid halides, in particular the acid dichlorides and the acid dibromides may be used. Thus, for example instead of using isophthalic acid, terephthalic acid, or a combination thereof, isophthaloyl dichloride, terephthaloyl dichloride, or a combination thereof may be used. The polyesters may also be obtained by melt-process condensation as described above, by solution phase condensation, or by transesterification polymerization wherein, for example, a dialkyl ester such as dimethyl terephthalate may be transesterified with the dihydroxy reactant using acid catalysis, to generate the polyester blocks. Branched polyester blocks, in which a branching agent, for example, a glycol having three or more hydroxyl groups or a trifunctional or multifunctional carboxylic acid has been incorporated, may be used. Furthermore, it may be desirable to have various concentrations of acid and hydroxyl end groups on the polyester blocks, depending on the ultimate end use of the composition.

The polycarbonate copolymers comprising arylate ester units may have an Mw of 2,000 to 100,000 g/mol, preferably 3,000 to 75,000 g/mol, more preferably 4,000 to 50,000 g/mol, more preferably 5,000 to 35,000 g/mol, and still more preferably 17,000 to 30,000 g/mol. Molecular weight determinations are performed using GPC using a cross linked styrene-divinyl benzene column, at a sample concentration of 1 milligram per milliliter, and as calibrated with bisphenol A polycarbonate standards. Samples are eluted at a flow rate of 1.0 ml/min with methylene chloride as the eluent.

In some aspects, the thermoplastic compositions include a combination of a poly(carbonate-siloxane-arylate) and an poly(carbonate-arylate). The weight ratio of the poly(carbonate-siloxane-arylate) to the poly(carbonate-arylate) may range from 10:1 to 1:10, from 9:1 to 1:9, from 1:8 to 8:1, from 1:5 to 5:1, from 1:4 to 4:1, from 1:3 to 3:1, from 1:2 to 2:1, 1:1.5 to 1.5 to 1, and 1:1.2 to 1.2 to 1, or 1:1.

The thermoplastic compositions include a poly(carbonate-siloxane-arylate) and a poly(carbonate-siloxane). The polysiloxane blocks of the poly(carbonate-siloxane-arylate) s and a poly(carbonate-siloxane) s comprise repeating diorganosiloxane units as in formula (10)

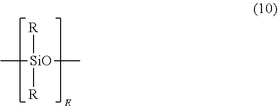

wherein each R is independently a C₁₋₁₃ monovalent organic group. For example, R may be a C₁₋₁₃ alkyl, C₁₋₁₃ alkoxy, C₂₋₁₃ alkenyl, C₂₋₁₃ alkenyloxy, C₃₋₆ cycloalkyl, C₃-6 cycloalkoxy, C₆-14 aryl, C₆₋₁₀ aryloxy, C₇₋₁₃ arylalkylene, C₇₋₁₃ arylalkylenoxy, C₇₋₁₃ alkylarylene, or C₇₋₁₃ alkylaryleneoxy. The foregoing groups may be fully or partially halogenated with fluorine, chlorine, bromine, or iodine, or a combination thereof. In an aspect, where a transparent poly(carbonate-siloxane) is desired, R is unsubstituted by halogen. Combinations of the foregoing R groups may be used in the same copolymer.

The value of E in formula (10) may vary widely depending on the type and relative amount of each component in the thermoplastic composition, the desired properties of the composition, and like considerations. Generally, E has an average value of 2 to 1,000, preferably 2 to 500, 2 to 200, or 2 to 125, 5 to 80, or 10 to 70. In an aspect, E has an average value of 10 to 80 or 10 to 40, and in still another aspect, E has an average value of 40 to 80, or 40 to 70. In an aspect, E has an average value of 2 to 40, or 5 to 20. Where E is of a lower value, e.g., less than 40, it may be desirable to use a relatively larger amount of the poly(carbonate-siloxane) copolymer. Conversely, where E is of a higher value, e.g., greater than 40, a relatively lower amount of the poly(carbonate-siloxane) copolymer may be used. A combination of a first and a second (or more) poly(carbonate-siloxane) copolymers may be used, wherein the average value of E of the first copolymer is less than the average value of E of the second copolymer.

In an aspect, the polysiloxane blocks are of formula (11)

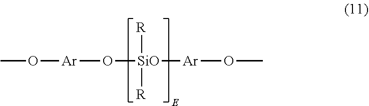

wherein E and R are as defined if formula (10); each R may be the same or different, and is as defined above; and Ar may be the same or different, and is a substituted or unsubstituted C₆₋₃₀ arylene, wherein the bonds are directly connected to an aromatic moiety. Ar groups in formula (11) may be derived from a C₆₋₃₀ dihydroxyarylene compound, for example a dihydroxyarylene compound of formula (3) or (6). Dihydroxyarylene compounds are 1,1-bis(4-hydroxyphenyl)methane, 1,1-bis(4-hydroxyphenyl)ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl)propane, 1,1-bis(4-hydroxyphenyl) n-butane, 2,2-bis(4-hydroxy-1-methylphenyl) propane, 1,1-bis(4-hydroxyphenyl)cyclohexane, bis(4-hydroxyphenyl sulfide), and 1,1-bis(4-hydroxy-t-butylphenyl) propane.

In another aspect, polysiloxane blocks are of formula (13)

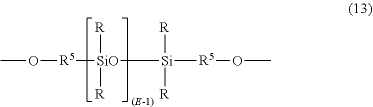

wherein R and E are as described above, and each R⁵ is independently a divalent C₁₋₃₀ organic group, and wherein the polymerized polysiloxane unit is the reaction residue of its corresponding dihydroxy compound. In a specific aspect, the polysiloxane blocks are of formula (14):

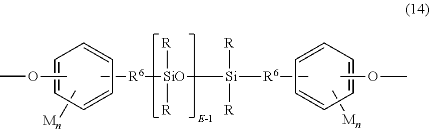

wherein R and E are as defined above. R⁶ in formula (14) is a divalent C₂₋₈ aliphatic group. Each M in formula (14) may be the same or different, and may be a halogen, cyano, nitro, C₁-8 alkylthio, C₁₋₈ alkyl, C₁₋₈ alkoxy, C₂₋₈ alkenyl, C₂₋₈ alkenyloxy, C₃₋₈ cycloalkyl, C₃₋₈ cycloalkoxy, C₆₋₁₀ aryl, C₆₋₁₀ aryloxy, C₇₋₁₂ aralkyl, C₇₋₁₂ aralkoxy, C₇₋₁₂ alkylaryl, or C₇₋₁₂ alkylaryloxy, wherein each n is independently 0, 1, 2, 3, or 4.

In an aspect, M is bromo or chloro, an alkyl such as methyl, ethyl, or propyl, an alkoxy such as methoxy, ethoxy, or propoxy, or an aryl such as phenyl, chlorophenyl, or tolyl; R⁶ is a dimethylene, trimethylene or tetramethylene; and R is a C₁₋₈ alkyl, haloalkyl such as trifluoropropyl, cyanoalkyl, or aryl such as phenyl, chlorophenyl or tolyl. In another aspect, R is methyl, or a combination of methyl and trifluoropropyl, or a combination of methyl and phenyl. In still another aspect, R is methyl, M is methoxy, n is one, and R⁶ is a divalent C₁₋₃ aliphatic group. Specific polysiloxane blocks are of the formula

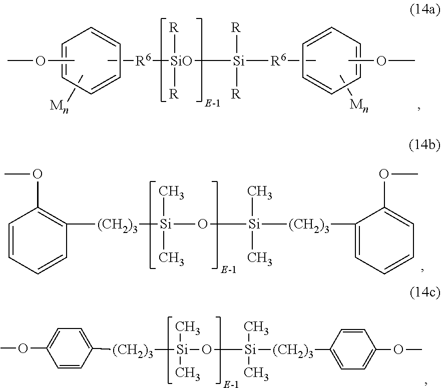

or a combination thereof, wherein E has an average value of 2 to 200, 2 to 125, 5 to 125, 5 to 100, 5 to 50, 20 to 80, or 5 to 20.

Blocks of formula (14) may be derived from the corresponding dihydroxy polysiloxane, which in turn may be prepared effecting a platinum-catalyzed addition between the siloxane hydride and an aliphatically unsaturated monohydric phenol such as eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. The poly(carbonate-siloxane) copolymers may then be manufactured, for example, by the synthetic procedure of European Patent Application Publication No. 0 524 731 A1 of Hoover, page 5, Preparation 2.

The poly(carbonate-siloxane) s of the thermoplastic compositions have 30-70 wt %, 35-65 wt %, 35-55 wt %, or 35-45 wt % of the polysiloxane based on the total weight of the poly(carbonate-siloxane) copolymer.

The poly(carbonate-siloxane) having 30-70 wt % siloxane content may be present in the composition in an amount effective to provide a total siloxane content of 0.5-10 wt % based on the total weight of the composition. Within that range, the poly(carbonate-siloxane) having 30-70 wt % siloxane content may be present in the composition in an amount effective to provide a total siloxane content of 0.5-4.0 wt %, or 0.5 to less than 4.0 wt %, or 1.0 to less than 4.0 wt %, each based on the total weight of the composition.

In applications where good aesthetic properties (i.e., no surface defects upon visual inspection) are desired, the poly(carbonate-siloxane) having 30-70 wt % siloxane content may be present in the composition in an amount effective to provide a total siloxane content of 0.5 to less than 4 wt % siloxane based on the total composition. Within that range, the poly(carbonate-siloxane) having 30-70 wt % siloxane content may be present in the composition in an amount effective to provide a total siloxane content of 0.5 to 3.5 wt %, 0.5 to less than 3.5 wt % siloxane, 0.5 to 3.0 wt %, 0.5 to less than 3.0 wt %, 0.5 to 2.5 wt %, 0.5 to less than 2.5 wt % siloxane, 0.5 to 2.0 wt %, 0.5 to less than 2.0 wt % siloxane based on the total composition.

The poly(carbonate-siloxane-arylate) of the thermoplastic compositions may include siloxane repeating units in addition to arylate ester units. In such aspects, the copolymers may include 50 to 99.8 mole percent of arylate ester units and 0.2 to 50 mole percent aromatic carbonate units. Within that range, the copolymer may include less than 30 mole percent resorcinol carbonate units and less than 35 mole percent bisphenol carbonate units. The poly(carbonate-siloxane-arylate) may include 4 to 50 siloxane units. The siloxane units of the poly(carbonate-siloxane-arylate) may be present in an amount of 0.2 to 10 wt % of the total weight of the composition.

The poly(carbonate-siloxane) s may have a weight average molecular weight of 21,000-50,000 g/mol. Within this range, the weight average molecular weight may be 25,000-45,000 g/mol, or 30,000-45,000 g/mol, or 32,000-43,000 g/mol, or 34,000-41,000 g/mol, or 35,000-40,000 g/mol. The weight average molecular weight may be measured by gel permeation chromatography using a crosslinked styrene-divinyl benzene column, at a sample concentration of 1 milligram per milliliter, and using polystyrene standards and calculated for polycarbonate. Poly(carbonate-siloxane) s can have a weight average molecular weight of 2,000 to 100,000 Daltons, preferably 5,000 to 50,000 Daltons as measured by gel permeation chromatography using a crosslinked styrene-divinyl benzene column, at a sample concentration of 1 milligram per milliliter, and as calibrated with polycarbonate standards.

The compositions may be substantially free of a poly(carbonate-siloxane) having a siloxane content of less than 30 wt %. As used herein, in this context, “substantially free of a poly(carbonate-siloxane) having a siloxane content of less than 30 wt %” means that the compositions have less than 5 wt %, less than 1 wt %, less than 0.5 wt %, less than 0.1 wt %, or less than 0.01 wt % of a poly(carbonate-siloxane) having less than 30 wt % siloxane content. In some aspects, a poly(carbonate-siloxane) having a siloxane content of less than 30 wt % is excluded from the composition.

The compositions may be substantially free of a poly(carbonate-siloxane) having a siloxane content of 20 wt % or less. As used herein, in this context, “substantially free of a poly(carbonate-siloxane) having a siloxane content of 20 wt % or less” means that the compositions have less than 5 wt %, less than 1 wt %, less than 0.5 wt %, less than 0.1 wt %, or less than 0.01 wt % of a poly(carbonate-siloxane) having a siloxane content of 20 wt % or less. In some aspects, a poly(carbonate-siloxane) having a siloxane content of 20 wt % or less is excluded from the composition.

The compositions may be substantially free of a poly(carbonate-siloxane) having a siloxane content having a siloxane content of 10 wt % or less. As used herein, in this context, “substantially free of a poly(carbonate-siloxane) having a siloxane content of 10 wt % or less” means that the compositions have less than 5 wt %, less than 1 wt %, less than 0.5 wt %, less than 0.1 wt %, or less than 0.01 wt % of a poly(carbonate-siloxane) having a siloxane content of 10 wt % or less. In some aspects, a poly(carbonate-siloxane) having a siloxane content of 10 wt % or less is excluded from the composition.

The thermoplastic compositions include a flame retardant. Useful flame retardants include organic compounds that include phosphorous, bromine, or chlorine. Non-brominated and non-chlorinated phosphorous-containing flame retardants may be preferred in certain applications for regulatory reasons, for example organic phosphates and organic compounds containing phosphorous-nitrogen bonds. Halogenated materials may also be used as flame retardants, for example bisphenols of which the following are representative: 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl) ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; and 2,2-bis-(3,5-dichloro-4-hydroxyphenyl)-propane 2,2 bis-(3-bromo-4-hydroxyphenyl)-propane. Other halogenated materials include 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, as well as oligomeric and polymeric halogenated aromatic compounds, such as a copolycarbonate of bisphenol A and tetrabromobisphenol A and a carbonate precursor, e.g., phosgene. Metal synergists, e.g., antimony oxide, may also be used with the flame retardant. When present, halogen containing flame retardants are present in amounts of 1 to 25 parts by weight, more preferably 2 to 20 parts by weight, based on 100 parts by weight of the total composition, excluding any filler.

The thermoplastic polycarbonate may include a brominated polycarbonate. The brominated polycarbonate may be an oligomer or a polymer, and may be derived from an aromatic dihydroxy compound of formula (2) wherein each Rh is bromine and n is 1 to 4; or a bisphenol of formula (3), wherein X^{a} is as defined for formula (3), p and q are each independently 0 to 4, provided that the sum of p and q is at least 1, and R^{a} is independently at each occurrence C₁₋₃ methyl, C₁₋₃ alkoxy, or bromine, provided that at least one R^{a} is bromine. In an aspect, a combination of two or more different brominated aromatic dihydroxy compounds may be used. Alternatively, the brominated polycarbonate may be derived from a combination of brominated and non-brominated aromatic dihydroxy compounds. If a non-brominated aromatic dihydroxy compound is used, any of the above-described bisphenols (3) may be used. In an aspect, when a non-brominated aromatic dihydroxy compound is used, the non-brominated aromatic dihydroxy compound may be bisphenol A. If a combination of brominated and non-brominated aromatic dihydroxy compounds is used, then preferably the combination includes at least 25 mole % (mol %) of the brominated dihydroxy aromatic compound, more preferably at least 25 to 55 mol % of the brominated dihydric phenol, so as to yield a flame retardant brominated polycarbonate. Branched brominated polycarbonate oligomers may also be used, as may compositions of a linear brominated polycarbonate oligomer and a branched brominated polycarbonate oligomer. Combinations of different brominated copolycarbonate oligomers may be used. Exemplary brominated polycarbonates are disclosed in U.S. Pat. No. 4,923,933 to Curry, U.S. Pat. No. 4,170,700 to Orlando et al., and U.S. Pat. No. 3,929,908 to Orlando et al.

The brominated polycarbonate may have a bromine content of 10 to 50 wt %, 15 to 40 wt %, 20 to 30 wt %, or 24 to 27.5 wt % each based on the weight of the brominated polycarbonate. Optionally the brominated polycarbonate may have phenol or 2,4,6-tribromophenol endcaps. The brominated polycarbonate may have an intrinsic viscosity of 0.2 to 1.5 deciliter per gram, measured in methylene chloride at 25° C. Within this range, the intrinsic viscosity may be 0.4 to 1 deciliter per gram. The brominated polycarbonate may have a Mw of 1,000 to 30,000 g/mol, for example 1,000 to 18,000 g/mol, or 2,000 to 15,000 g/mol, or 3,000 to 12,000 g/mol; or alternatively 15,000 to 25,000 g/mol, or 20,000 to 25,000 g/mol. The brominated polycarbonates may branched or linear, or a combination of branched and linear brominated polycarbonates may be used.

In an aspect, the brominated aromatic dihydroxy compound may be 2,2-bis(3,5-dibromo-4-hydroxyphenyl)propane (2′,6,6′-tetrabromo-4,4′-isopropylidenediphenol (TBBPA)), bis(3,5-dibromo-4-hydroxyphenyl) menthanone, or 2,2′,6,6′-tetramethyl-3,3′,5,5′-tetrabromo-4,4′-biphenol; and the non-brominated aromatic dihydroxy compounds for copolymerization with the brominated aromatic dihydroxy compounds include bisphenol A, bis(4-hydroxyphenyl)methane, 2,2-bis(4-hydroxy-3-methylphenyl) propane, 4,4-bis(4-hydroxyphenyl) heptane, and (3,3′-dichloro-4,4′-dihydroxydiphenyl) methane. In another preferred aspect, the brominated polycarbonate includes brominated carbonate units derived from TBBPA and carbonate units derived from bisphenol A, and more preferably comprises 30 to 70 wt % of TBBPA and 30 to 70 wt % of bisphenol A, or 45 to 55 wt % of TBBPA and 45 to 55 wt % of bisphenol A.

The brominated polycarbonate may be used in an amount that contributes 2 to 20 wt % of bromine to the composition, based on the total weight of the composition.

In some aspects, the brominated polycarbonate is present from 10 to 15 wt %. In certain aspects, the brominated polycarbonate is present from 10 to 15 wt % and the brominated polycarbonate may have a bromine content of 20 to 30 wt %, preferably 24 to 27.5 wt %, each based on the weight of the brominated polycarbonate.

Alternatively, the thermoplastic composition may be essentially free of chlorine and bromine. “Essentially free of chlorine and bromine” is defined as having a bromine or chlorine content of less than or equal to 100 parts per million by weight (ppm), less than or equal to 75 ppm, or less than or equal to 50 ppm, based on the total parts by weight of the composition, excluding any filler.

Inorganic flame retardants may also be used, for example salts of C₁₋₁₆ alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate; salts such as Na₂CO₃, K₂CO₃, MgCO₃, CaCO₃, and BaCO₃, or fluoro-anion complexes such as Li₃AlF₆, BaSiF₆, KBF₄, K₃AlF₆, KAlF₄, K₂SiF₆, or Na₃AlF₆. When present, inorganic flame retardant salts are present in amounts of 0.01 to 10 parts by weight, more preferably 0.02 to 1 parts by weight, based on 100 parts by weight of the total composition, excluding any filler.

The flame retardant may include an organophosphorous compound. In the aromatic organophosphorous compounds that have at least one organic aromatic group, the aromatic group may be a substituted or unsubstituted C₃₋₃₀ group containing one or more of a monocyclic or polycyclic aromatic moiety (which may optionally contain with up to three heteroatoms (N, O, P, S, or Si)) and optionally further containing one or more nonaromatic moieties, for example alkyl, alkenyl, alkynyl, or cycloalkyl. The aromatic moiety of the aromatic group may be directly bonded to the phosphorous-containing group, or bonded via another moiety, for example an alkylene group. The aromatic moiety of the aromatic group may be directly bonded to the phosphorous-containing group, or bonded via another moiety, for example an alkylene group. In an aspect the aromatic group is the same as an aromatic group of the polycarbonate backbone, such as a bisphenol group (e.g., bisphenol A), a monoarylene group (e.g., a 1,3-phenylene or a 1,4-phenylene), or a combination comprising at least one of the foregoing.

The phosphorous-containing group may be a phosphate (P(═O)(OR)₃), phosphite (P(OR)₃), phosphonate (RP(═O)(OR)₂), phosphinate (R₂P(═O)(OR)), phosphine oxide (R³P(═O)), or phosphine (R³P), wherein each R in the foregoing phosphorous-containing groups may be the same or different, provided that at least one R is an aromatic group. A combination of different phosphorous-containing groups may be used. The aromatic group may be directly or indirectly bonded to the phosphorous, or to an oxygen of the phosphorous-containing group (i.e., an ester).

In an aspect the aromatic organophosphorous compound is a monomeric phosphate. Representative monomeric aromatic phosphates are of the formula (GO)₃P═O, wherein each G is independently an alkyl, cycloalkyl, aryl, alkylarylene, or arylalkylene group having up to 30 carbon atoms, provided that at least one G is an aromatic group. Two of the G groups may be joined together to provide a cyclic group. In some aspects G corresponds to a monomer used to form the polycarbonate, e.g., resorcinol. Exemplary phosphates include phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, and the like. A specific aromatic phosphate is one in which each G is aromatic, for example, triphenyl phosphate, tricresyl phosphate, isopropylated triphenyl phosphate, and the like.

Di- or polyfunctional aromatic organophosphorous compounds are also useful, for example, compounds of the formulas

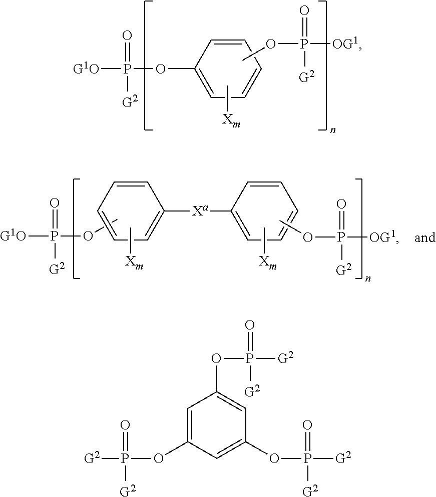

wherein each G¹ is independently a C₁₋₃₀ hydrocarbyl; each G² is independently a C₁₋₃₀ hydrocarbyl or hydrocarbyloxy; X^{a} is as defined in formula (3) or formula (4); each X is independently a bromine or chlorine; m is 0 to 4, and n is 1 to 30. In a specific aspect, X^{a} is a single bond, methylene, isopropylidene, or 3,3,5-trimethylcyclohexylidene.

Specific aromatic organophosphorous compounds are inclusive of acid esters of formula (9)

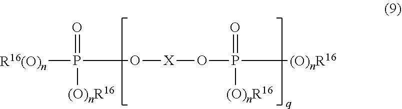

wherein each R¹⁶ is independently C₁₋₈ alkyl, C₅₋₆ cycloalkyl, C₆₋₂₀ aryl, or C₇₋₁₂ arylalkylene, each optionally substituted by C₁₋₁₂ alkyl, specifically by C₁₋₄ alkyl and X is a mono- or poly-nuclear aromatic C₆₋₃₀ moiety or a linear or branched C₂₋₃₀ aliphatic radical, which may be OH-substituted and may contain up to 8 ether bonds, provided that at least one R¹⁶ or X is an aromatic group; each n is independently 0 or 1; and q is from 0.5 to 30. In some aspects each R¹⁶ is independently C₁₋₄ alkyl, naphthyl, phenyl(C₁₋₄)alkylene, aryl groups optionally substituted by C₁₋₄ alkyl; each X is a mono- or poly-nuclear aromatic C₆₋₃₀ moiety, each n is 1; and q is from 0.5 to 30. In some aspects each R¹⁶ is aromatic, e.g., phenyl; each X is a mono- or poly-nuclear aromatic C₆₋₃₀ moiety, including a moiety derived from formula (2); n is one; and q is from 0.8 to 15. In other aspects, each R¹⁶ is phenyl; X is cresyl, xylenyl, propylphenyl, or butylphenyl, one of the following divalent groups

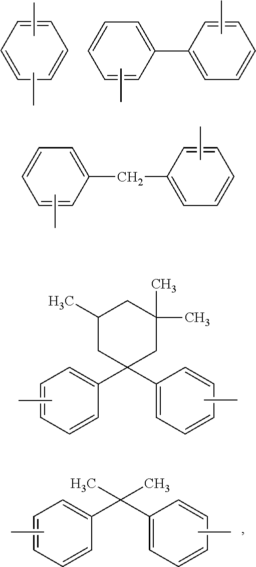

or a combination comprising one or more of the foregoing; n is 1; and q is from 1 to 5, or from 1 to 2. In some aspects at least one R¹⁶ or X corresponds to a monomer used to form the polycarbonate, e.g., bisphenol A, resorcinol, or the like. Aromatic organophosphorous compounds of this type include the bis(diphenyl) phosphate of hydroquinone, resorcinol bis(diphenyl phosphate) (RDP), and bisphenol A bis(diphenyl) phosphate (BPADP), and their oligomeric and polymeric counterparts.

The organophosphorous flame retardant containing a phosphorous-nitrogen bond may be a phosphazene, phosphonitrilic chloride, phosphorous ester amide, phosphoric acid amide, phosphonic acid amide, phosphinic acid amide, or tris(aziridinyl) phosphine oxide. These flame-retardant additives are commercially available. In an aspect, the organophosphorous flame retardant containing a phosphorous-nitrogen bond is a phosphazene or cyclic phosphazene of the formulas

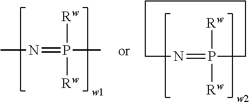

wherein w1 is 3 to 10,000; w2 is 3 to 25, or 3 to 7; and each R″ is independently a C₁₋₁₂ alkyl, alkenyl, alkoxy, aryl, aryloxy, or polyoxyalkylene group. In the foregoing groups at least one hydrogen atom of these groups may be substituted with a group having an N, S, O, or F atom, or an amino group. For example, each R″ may be a substituted or unsubstituted phenoxy, an amino, or a polyoxyalkylene group. Any given R″ may further be a crosslink to another phosphazene group. Exemplary crosslinks include bisphenol groups, for example bisphenol A groups. Examples include phenoxy cyclotriphosphazene, octaphenoxy cyclotetraphosphazene decaphenoxy cyclopentaphosphazene, and the like. In an aspect, the phosphazene has a structure represented by the formula

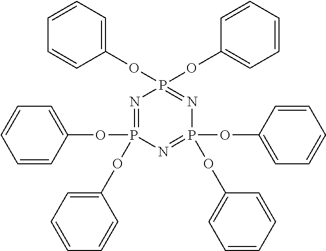 [SMILES: c1ccc(OP2(Oc3ccccc3)=NP(Oc3ccccc3)(Oc3ccccc3)=NP(Oc3ccccc3)(Oc3ccccc3)=N2)cc1]

Commercially available phenoxyphosphazenes having the aforementioned structures are LY202 manufactured and distributed by Lanyin Chemical Co., Ltd, FP-110 manufactured and distributed by Fushimi Pharmaceutical Co., Ltd, and SPB-100 manufactured and distributed by Otsuka Chemical Co., Ltd.

Depending on the particular organophosphorous compound used, the thermoplastic compositions can comprise from 2 to 12 wt %, or 0.3 to 8.5 wt %, or 0.5 to 8.0 wt %, or 3.5 to 7.5 wt % of the organophosphorous flame retardant, each based on the total weight of the composition. The phosphorous content of the compositions ranges from 0.1 to 1.0 wt % phosphorous, or 0.5 to 1 wt % phosphorous, based on the total weight of the composition.

The thermoplastic composition may include various additives ordinarily incorporated into polymer compositions of this type, with the proviso that the additive(s) are selected so as to not significantly adversely affect the desired properties of the thermoplastic composition, in particular chemical resistance, impact, smoke, and heat release properties. Such additives may be mixed at a suitable time during the mixing of the components for forming the composition. Additives include fillers, reinforcing agents, antioxidants, heat stabilizers, light stabilizers, ultraviolet (UV) light stabilizers, plasticizers, lubricants, mold release agents, antistatic agents, colorants such as such as titanium dioxide, carbon black, and organic dyes, surface effect additives, radiation stabilizers, flame retardants, and anti-drip agents. A combination of additives may be used, for example a combination of an anti-oxidant, a colorant composition, and an antimicrobial agent. In general, the additives are used in the amounts generally known to be effective. For example, the total amount of the additives (other than any impact modifier, filler, or reinforcing agents) may be 0.1-10 wt %, based on the total weight of the thermoplastic composition.

In an aspect, the thermoplastic compositions may optionally comprise an antimicrobial agent. Any antimicrobial agent generally known may be used either individually or in combination (i.e., of two or more). Exemplary antimicrobial agents may include, but are not limited to a metal containing agent, such as Ag, Cu, Al, Sb, As, Ba, Bi, B, Au, Pb, Hg, Ni, Th, Sn, Zn containing agent. In an aspect, the agent may be silver-containing agent. A suitable silver-containing agent may contain a silver ion, colloidal silver, silver salt, silver complex, silver protein, silver nanoparticle, silver functionalized clay, zeolite containing silver ions or any combinations thereof. Silver salts or silver complexes may include silver acetate, silver benzoate, silver carbonate, silver ionate, silver iodide, silver lactate, silver laureate, silver nitrate, silver oxide, silver palpitate, silver sulfadiazine, silver sulfate, silver chloride, or any combinations thereof.

When present, the antimicrobial agent may be included in an amount of 0.001 to 15 wt %, or 0.0001 to 5 wt % based on the total weight of the thermoplastic composition. In an aspect, the composition may contain a silver-containing agent(s) in amounts such that and the silver content in the composition of 0.01-5 wt %.

In some aspects, the thermoplastic compositions include a combination of an organophosphorous flame retardant and the poly(carbonate-siloxane) present in an amount effective to provide 2 wt % or less siloxane content to the entire compositions. Within that range, the poly(carbonate-siloxane) can be present in an amount effective to provide 0.5 to 1.8 wt %, 0.5 to 1.6 wt %, or 0.5 to 1.5 wt % total siloxane content.

In some aspects, the thermoplastic compositions include a brominated polycarbonate as the flame retardant and the poly(carbonate-siloxane) is present in an amount effective to provide 0.5 to less than 4 wt %, 0.5 to 3.5 wt %, or 0.5 to 3.0 wt % total siloxane content.

The thermoplastic compositions may have a combination of desired properties. As discussed herein, the thermoplastic compositions are formulated to meet strict flammability requirements. The thermoplastic composition may have an OSU integrated 2-minute heat release test value of less than 65 kW-min/m² and a peak heat release rate of less than 65 kW/m² as measured using the method of FAR F25.4, in accordance with Federal Aviation Regulation FAR 25.853 (d), on parts with a thickness of 1.5 or 3 mm.

Smoke density testing (ASTM E-662-83, ASTM F-814-83, Airbus ABD0031, Boeing BSS 7239) was performed on 7.5×7.5 cm plaques of 1.5 mm thickness according to the method shown in FAR 25.853 (d), and in Appendix F, section V (FAR F25.5). Smoke density was measured under flaming mode. Smoke density (Ds) at 1.5 min and 4.0 min were reported.

As discussed above, the thermoplastic compositions are formulated to meet strict flammability requirements. The thermoplastic compositions may have an E662 smoke test DsMax value of less than 200 when tested at a thickness of 1.5 mm or 3.0 mm. The thermoplastic compositions may further have an OSU integrated 2 minute heat release test value of less than 65 kW-min/m² and a peak heat release rate of less than 65 kW-min/m² as measured using the method of FAR F25.4, in accordance with Federal Aviation Regulation FAR 25.853 (d), on parts with a thickness of 1.5 or 3 mm. The thermoplastic compositions may further have excellent impact properties. The compositions may have a notched Izod impact resistance of greater than 500 J/m measured on notched 3.2 mm bars at 23° C., in accordance with the ASTM-D256-10 (2018) standard.

Advantageously, the thermoplastic compositions have improved chemical resistance. In an exemplary aspect, the thermoplastic compositions may have a retention of tensile stress at yield of at least 90% and a strain at break retention of 80-139% after exposure to SANI-CLOTH AF3 for 24 hours at a temperature of 23° C. under 1% strain compared to non-exposed reference sample of the same composition. In an exemplary aspect, the polycarbonate composition may have a yield tensile stress retention of at least 90% and strain at break retention between 80-139% according to ISO527 after exposure to a 1:1 solution of HONEY BEE 90 in water for 20 hours at a temperature of 23° C. under 1% strain compared to non-exposed reference sample of the same composition.

The thermoplastic compositions may be manufactured by various methods. For example, powdered components are first blended, optionally with fillers in a HENSCHEL-Mixer® high speed mixer. Other low shear processes, including but not limited to hand mixing, may also accomplish this blending. The blend is then fed into the throat of a twin-screw extruder via a hopper. Alternatively, at least one of the components may be incorporated into the composition by feeding directly into the extruder at the throat or downstream through a side-stuffer. Additives may also be compounded into a masterbatch with a desired polymeric polymer and fed into the extruder. The extruder is generally operated at a temperature higher than that necessary to cause the composition to flow. The extrudate is immediately quenched in a water bath and pelletized. The pellets so prepared may be one-fourth inch long or less as desired. Such pellets may be used for subsequent molding, shaping, or forming.

Shaped, formed, or molded articles comprising the thermoplastic compositions are also provided. The thermoplastic compositions may be molded into useful shaped articles by a variety of means such as injection molding, extrusion, rotational molding, blow molding, and thermoforming to form articles. Thus, the thermoplastic compositions may be used to form a foamed article, a molded article, a thermoformed article, an extruded film, an extruded sheet, a layer of a multi-layer article, e.g., a cap-layer, a substrate for a coated article, or a substrate for a metallized article. These values may be obtained in articles having a wide range of thicknesses, for example from 0.1 to 10 mm, or 0.5 to 5 mm. The articles may also be additively formed using a powder or filament comprising the thermoplastic compositions disclosed herein.

The thermoplastic compositions are particularly useful in aircraft, for example a variety of aircraft compartment interior applications. Accordingly, the articles may be interior components for aircraft, including access panels, access doors, air flow regulators baggage storage doors, display panels, display units, door handles, door pulls, enclosures for electronic devices, food carts, food trays, grilles, handles, magazine racks, seat components, partitions, refrigerator doors, seat backs, side walls, tray tables, trim panels, ceiling paneling, flaps, boxes, hoods, louvers, insulation material and the body shell in interiors, side walls, front walls/end walls, partitions, room dividers, interior doors, interior lining of the front-/end-wall doors and external doors, luggage overhead luggage racks, vertical luggage rack, luggage container, luggage compartments, windows, window frames, kitchen interiors, surfaces or a component assembly comprising at least one of the foregoing, and the like. The thermoplastic compositions may be formed (e.g., molded) into sheets that may be used for any of the above-mentioned components. It is generally noted that the overall size, shape, thickness, optical properties, and the like of the thermoplastic sheet may vary depending upon the desired application.

The thermoplastic compositions are further illustrated by the following non-limiting examples.

### EXAMPLES

The following components are used in the examples. Unless specifically indicated otherwise, the amount of each component is in wt %, based on the total weight of the composition.

The materials shown in Table 1 were used.

TABLE 1

| Component | Description | Source |
|---|---|---|
| ITR-PC-Si | Poly(bisphenol A/resorcinol carbonate-resorcinol phthalate-dimethyl siloxane) | SABIC |
| | having 8-12 mol % bisphenol A carbonate linkages, 8-12 mol % resorcinol | |
| | carbonate linkages, 83 mol % resorcinol phthalate ester linkages with an | |
| | isophthalate:terephthalate ratio of 1:1, and 0.8-1.2 wt % of a eugenol-linked D10 | |
| | dimethylsiloxane; produced via interfacial polymerization, para-cumyl phenol | |
| | endcapped; Mw = 22,500-26,500 g/mol as determined by GPC using polystyrene | |
| | standards and calculated for polycarbonate | |
| ITR-PC-1 | Poly(bisphenol A carbonate-resorcinol phthalate) having 8-12 mol % bisphenol A | SABIC |
| | carbonate linkages, 8-12 mol % resorcinol carbonate linkages, 78-82 mol % | |
| | resorcinol phthalate ester linkages with an isophthalate:terephthalate ratio of | |
| | 1:1;,; produced via interfacial polymerization, para-cumyl phenol endcapped Mw = | |
| | 20,000-22,000 g/mol as per GPC using polystyrene standards and calculated for | |
| | polycarbonate | |
| PC-Si-1 | Polycarbonate-siloxane copolymer having a siloxane content of 40 wt %, average | SABIC |
| | PDMS block length of 45 units, having a Mw of 37,000 to 38,000 grams per mole | |
| | as determined by gel permeation chromatography using polystyrene standards and | |
| | calculated for polycarbonate, produced by interfacial polymerization and | |
| | endcapped with p-cumylphenol | |
| PC-Si-2 | Poly(bisphenol A carbonate-dimethylsiloxane) copolymer produced via interfacial | SABIC |
| | polymerization, 20 wt % siloxane, average siloxane block length = 45 units (D45), | |
| | Mw = 29,000-31,000 g/mol as determined by GPC using polystyrene standards | |
| | and calculated for polycarbonate, para-cumylphenol (PCP) end-capped, | |
| PEPQ | Tetrakis(2,4-di-tert-butylphenyl) [1,1′-biphenyl]-4,4′-diylbis(phosphonite), | CLARIANT |
| | available as IRGAPHOS P-EPQ | |
| Br-PC | Tetrabromo-bisphenol A-co-bisphenol A, bromine content of 26 wt %, Mw = | SABIC |
| | 22,500 to 24,500/mol as per GPC using polystyrene standards and calculated for | |
| | polycarbonate; produced via interfacial polymerization, para-cumylphenol (PCP) | |
| | end-capped | |
| P-FR | Oligomeric phosphate ester, available as FYROLFLEX SOL-DP (10.7 wt % | ICL |
| | phosphorous) | INDUSTRIAL |
| ADD1 | Silver phosphate glass, available as IB15, as a 10 wt % masterbatch in ITR-PC-1 | Microban |
| ADD2 | Titanium dioxide | KRONOS |
| ADD3 | Carbon black | CABOT |

The testing samples were prepared as described below and the following test methods were used.

Typical compounding procedures are described as follows. A masterbatch of ADD1 (10 wt % in ITR-PC-Si) was compounded as described below prior to the preparation of the composition. The raw materials and the ADD1 masterbatch were compounded on a 25 mm Werner Pfleiderer ZSK co-rotating twin-screw extruder with a vacuum vented standard mixing screw operated at a screw speed of 300 rpm. The temperature profile is given in Table 1. The strand was cooled through a water bath prior to pelletizing. The pellets were dried for 3-4 hours at 90-110° C. in a forced air-circulating oven prior to injection molding. A typical extrusion profile is listed in Table 2. The conditions differ based on whether a brominated polycarbonate is present in the composition.

TABLE 2

| | | Brominated | Brominated |
|---|---|---|---|
| | | Polycarbonate | Polycarbonate |
| | | present, 25 | not present, |
| Parameters | Unit | mm ZSK | 25 mm ZSK |
| Die | — | | |
| Feed temperature | ° C. | 40 | 40 |
| Zone 1 temp. | ° C. | 180 | 180 |
| Zone 2 temp. | ° C. | 230 | 230 |
| Zone 3 temp. | ° C. | 250 | 250 |
| Zone 4-8 temp. | ° C. | 275 | 260 |
| Die temperature | ° C. | 275 | 260 |
| Screw speed | rpm | 300 | 300 |
| Throughput | kg/h | 15-25 | 15-25 |
| Vacuum 1 | bar | 0.3 | 0.3 |

An Engel 45, 75, 90 molding machine was used to mold the test parts for standard physical property testing. (for parameters see Table 3).

TABLE 3

| | | Brominated | Brominated |
|---|---|---|---|
| | | Polycarbonate | Polycarbonate |
| Parameters | Unit | not present | present |
| Pre-drying time | h | 6 | 3-4 |
| Pre-drying temp. | ° C. | 95 | 90-110 |
| Hopper temp. | ° C. | 40 | 40 |
| Zone 1 temp. | ° C. | 240 | 265 |
| Zone 2 temp. | ° C. | 250 | 275 |
| Zone 3 temp. | ° C. | 260 | 285 |
| Nozzle temp. | ° C. | 255 | 280 |
| Mold temperature | ° C. | 65 | 85 |
| Screw speed | rpm | 100 | 100 |
| Back pressure | bar | 5 | 5 |
| Approx. Injection time | s | 1.7 | 1.7 |
| Approx. cycle time | s | 37 | 37 |

Sample preparation and testing methods are described in Table 4.

TABLE 4

| Property | Standard | Conditions | | Specimen Type |
|---|---|---|---|---|
| Heat release | FAR 25.853 (d), | 35 | kJ/m² | 15.2 cm × 15.2 cm × 3 mm thick |
| | and in Appendix | | | |
| | F, section IV | | | |
| | (FAR F25.4) | | | |
| Smoke Density | ASTM E-662-83, | 25 KW, | | 75 mm × 75 mm × 1.5 mm; |
| (DS4) | ASTM F-814-83, | flaming mode | | 75 mm × 75 mm × 3.0 mm |
| | Airbus ABD0031, | | | |
| | Boeing BSS 7239; | | | |
| | FAR 25.853 (d), | | | |
| | and in Appendix | | | |
| | F, section V (FAR | | | |
| | F25.5) | | | |
| Vertical burn | FAR 25.853a, | | | 76 mm × 305 mm × 1.5 mm; |
| | Appendix F, Part | | | 76 mm × 305 mm × 3.0 mm |
| | I, (a), 1, (i) | | | |
| Izod Impact | ASTM D256- | 23° | C. | ASTM Impact bar, 3.2 mm thick |

| | | | |
|---|---|---|---|
| (notched) | 2018 | | |
| Antimicrobial | ISO22196 | | 75 × 75 × 3 mm |
| efficacy | | | |
| Melt volume flow | ISO 1133 | 300° C., 1.2 kg, 300 | pellets |
| rate | | seconds | |
| Melt volume flow | ISO 1133 | 300° C., 1.2 kg, 900 | pellets |
| rate | | seconds | |
| Chemical resistance | ISO527 | Sani-cloth, 1% strain, | 4 mm thick ISO527 bars |
| compatibility | | 24 h, 23° C. | |
| Chemical resistance | ISO527 | Honey Bee 90, 1% | 4 mm thick ISO527 bars |
| compatibility | | strain, 20 h, 50/50, | |
| | | 23° C. | |
| Delamination after | | | Visual assessment of surface; |
| molding | | | Ranked accordingto degree of |
| | | | delamination (1 = good, no |
| | | | delamination;, 2 = average, no visual |
| | | | defects;, 3 = poor, surface defects) |

Environmental stress cracking resistance (ESCR) describes the accelerated failure of polymeric materials, as a combined effect of environment, temperature, and stress. The failure mainly depends on the characteristics of the material, chemical, exposure condition, and the magnitude of the stress. The ISO tensile bars were clamped to a semicircular jig to impart a constant strain of 1.0%. The bars were then exposed to SANICLOTH wipes or cloths wetted with a 1:1 aqueous solution of HONEYBEE 90, each for 24 h and 20 h, respectively, at 23° C. Tensile testing was performed using the ZwickRoell Z020 universal testing machine. Chemical resistance is assessed according to Table 5 below.

TABLE 5
Chemical resistance ratings based on strain at break retention

| Rating | Strain at break retention (%) | Inference |
|---|---|---|
| Compatible | 80-139% | Property retained |
| Marginal | 65-79% | Onset of possible failure |
| Not compatible | <65% - embrittlement | Craze/crack observed |
| | >=140% - plasticization | Specimens softened |

### Examples 1-8

Table 6 shows the compositions and properties for the following comparative examples and examples. Comparative examples are indicated with an asterisk.

TABLE 6

| | Unit | 1* | 2* | 3 | 4 | 5* | 6* | 7 | 8 |
|---|---|---|---|---|---|---|---|---|---|
| ITR-PC-Si | wt % | 93.44 | 90.94 | 89.69 | 85.94 | 83.44 | 88 | 78.4 | 75.44 |
| PC-Si-1 | wt % | | 2.5 | 3.75 | 7.5 | 10 | | 7.5 | 7.5 |
| FR-1 | wt % | 6.5 | 6.5 | 6.5 | 6.5 | 6.5 | | | 6.5 |
| Br-PC | wt % | | | | | | 11.94 | 11.94 | |
| ADD1 | wt % | | | | | | | | 10.5 |
| ADD2 | wt % | 5 | 5 | 5 | 5 | 2.5 | | | |
| PEPQ | wt % | 0.06 | 0.06 | 0.06 | 0.06 | 0.06 | 0.06 | 0.06 | 0.06 |
| % siloxane from PC-Si-1 | wt % | 0 | 1.0 | 1.5 | 3.0 | 4.0 | 0 | 3.0 | 3.0 |
| % phosphorous | wt % | 0.69 | 0.69 | 0.69 | 0.69 | 0.69 | | | 0.69 |
| Total | wt % | 100 | 100 | 100 | 100 | 100 | 100 | 100 | 100 |

Properties

| | | | | | | | | | |
|---|---|---|---|---|---|---|---|---|---|
| Peak Heat Release Rate | kW/m² | 37 | | | 61 | 48 | | 61 | |
| Total heat release rate at 2 min | kW*min/m² | 21 | | | 33 | 28 | | 32 | |
| Smoke Density at 4 min | | 66.1 | 141.5 | | 136.7 | 135.9 | 44 | 116 | 111 |
| Notched Izod impact | J/m | 112 | 165 | 734 | 747 | 771 | 194 | 748 | 75 |
| MVR 300° C./1.2/300 | cm³/10 min | 8.5 | 7.0 | 8.0 | 7.1 | 5.5 | 3.8 | 2.8 | 7 |
| MVR 300° C./1.2/900 | cm³/10 min | 9 | | | 7.3 | 5.5 | 4.1 | 3 | 10 |
| % retention (stress at | % | 0 | 0 | | 99 | | | | |
| yield) after Honeybee 90 | | | | | | | | | |
| (1% strain, 20 h, 50/50 | | | | | | | | | |
| solution in water) | | | | | | | | | |
| % retention (strain at | % | 0 | 0 | | 97 | | | | |
| break) after Honeybee 90 | | | | | | | | | |
| (1% strain, 20 h, 50/50 | | | | | | | | | |
| solution in water) | | | | | | | | | |
| Tensile (stress at yield) | MPa | 86 | | | 100 | | | | |
| after Sani-cloth (1% | | | | | | | | | |
| strain, 24 h) | | | | | | | | | |
| Tensile (strain at break) | MPa | 9 | | | 85 | | | | |
| after Sani-cloth (1% | | | | | | | | | |
| strain, 24 h) | | | | | | | | | |
| % reduction E. Coli | % | 51 | | | | | | | 99.99 |
| % reduction S. Aureus | % | 0 | | | | | | | 99.99 |
| Delamination after molding | | 1 | 1 | 1 | 2 | 3 | 1 | 2 | 2 |

Examples 3-4 and Comparative Example 5 show that when a polycarbonate siloxane having a siloxane content of 40 wt % is incorporated into compositions including a poly(carbonate-siloxane-arylate) and a phosphorous-containing flame retardant (FR-1), this results in a substantial improvement in impact resistance as compared to Comparative Examples 1 and 2, while also providing the combination of heat release and smoke density properties for compliance with the requirements of the aircraft industry.

Example 4 also shows that in addition to improved impact resistance, incorporation of a polycarbonate siloxane having a siloxane content of 40% may also provide improved chemical resistance to Honeybee90 and Sani-cloth AF3, two widely known cleaning agents (compare Example 4 with Comparative Example 1).

Example 7 shows a similar improvement in impact while maintaining heat release and smoke density properties may be obtained when a polycarbonate siloxane having a siloxane content of 40% is incorporated into compositions including a poly(carbonate-siloxane-arylate) and a brominated polycarbonate flame retardant (compare Example 7 with Comparative Example 6).

Example 8 shows that the addition of an antimicrobial agent to compositions including a poly(carbonate-siloxane-arylate) and a polycarbonate siloxane having a siloxane content of 40 wt % provide antimicrobial activity against E. coli and S. aureus, while maintaining the impact resistance, heat release, and smoke density properties.

Table 7 shows the compositions and properties for the following comparative examples and examples. Comparative examples are indicated with an asterisk.

TABLE 7

| | Unit | 9* | 10 | 11 | 12* | 13 | 14* |
|---|---|---|---|---|---|---|---|
| ITR-PC-Si | wt % | 83.44 | 88.44 | 93.44 | 43.75 | 40 | 78.44 |
| ITR-PC-1 | | | | | 42.15 | 38.4 | |
| PC-Si-1 | wt % | | 5 | 7.5 | | 7.5 | |
| PC-Si-2 | wt % | 10 | | | | | 15 |
| Br-PC | | | | | 11.94 | 11.94 | |
| FR-1 | wt % | 6.5 | 6.5 | 6.5 | | | 6.5 |
| PEPQ | wt % | 0.06 | 0.06 | 0.06 | 0.06 | 0.06 | 0.06 |
| ADD2 | wt % | | | | 2 | 2 | 2 |
| ADD3 | wt % | | | | 0.1 | 0.1 | |
| % siloxane (in either | wt % | 2.0 | 2.0 | 3.0 | | 3.0 | 3.0 |
| PC-Si-1 or PC-Si-2) | | | | | | | |
| % phosphorous | wt % | 0.69 | 0.69 | 0.69 | | | 0.69 |
| Total | wt % | 100 | 100 | 100 | 100 | 100 | 100 |
| Peak Heat Release Rate | kW/m² | 54 | | 61 | | 45 | |
| Total heat release rate at 2 min | kW*min/m² | 35 | | 33 | | 24 | |
| Smoke Density | | 142 | 187 | 137 | 45 | 60 | |
| Izod impact | J/m | 695 | 768 | 747 | 194 | 670 | |
| MVR 300° C./1.2/300 | cm³/10 min | 7.2 | 4.2 | 7.1 | 3.8 | 4 | |
| MVR 300° C./1.2/900 | cm³/10 min | 7.8 | 4.3 | 7.3 | 4.1 | 4.2 | |
| % retention (stress at yield) after | % | 0 | 92 | 99 | 0 | 100 | |
| Honeybee 90 (1%, 20 h, 50/50) | | | | | | | |
| % retention (strain at break) after | % | 0 | 29 | 97 | 0 | 99 | |
| Honeybee 90 (1% strain, 20 h, 50/50 | | | | | | | |
| in water) | | | | | | | |
| Tensile (stress at yield) after Sani- | MPa | | 95 | 100 | 0 | | |
| cloth (1% strain, 24 h) | | | | | | | |
| Tensile (strain at break) after Sani- | MPa | | 15 | 85 | | | |
| cloth (1% strain, 24 h) | | | | | | | |
| Delamination after molding | | 2 | 2 | 2 | 2 | 1 | 3 |

Table 7 shows that compositions including a polycarbonate siloxane having a siloxane content of 40 wt % provides superior chemical resistance to compositions including a polycarbonate siloxane having a siloxane content of 20 wt % (compare Examples 10-11 with Comparative Example 9). Even though Comparative Example 9, which has a 10 wt % loading of a polycarbonate siloxane having a siloxane content of 20 wt % has an equivalent siloxane content (based on the total weight of the composition) to that of Example 10, Example 10 demonstrated superior chemical resistance to Comparative Example 9.

Comparative Example 12 and Example 13 each include a mixture of a poly(carbonate-siloxane-arylate), a poly(arylate-carbonate), and a poly(carbonate-siloxane). Comparison of Comparative Example 12 with Example 13 shows that when a portion of the poly(carbonate-siloxane-arylate) is replaced by a poly(arylate-carbonate) in compositions including a poly(carbonate-siloxane having 40 wt % siloxane (instead of a poly(carbonate-siloxane having 20 wt % siloxane as is the case in Comparative Example 12), a desired combination of properties (e.g., chemical resistance, impact resistance, heat release, and smoke density) are achieved.

Furthermore, as shown by Tables 6 and 7, the wt % siloxane in the compositions affects the aesthetic properties, for example, the degree of delamination. The degree of delamination was determined by visual inspection and the samples were ranked for comparative purposes. A ranking of “1” indicates that the composition provided good aesthetic properties and had no delamination. A ranking of “2” indicates that the composition has no surface defects upon visual inspection. A ranking of “3” indicates that the composition provided a molded sample with poor aesthetic properties, having surface defects upon visual inspection. When the poly(carbonate-siloxane) was PC-Si-1, 10 wt % was the maximum loading that was tolerated in order to achieve a ranking of 1 or 2. When the loading of PC-Si-1 was increased to 10 wt %, corresponding to an amount effective to provide 4 wt % siloxane to the entire composition (see Comparative Example 5), delamination was observed. Similarly, when the poly(carbonate-siloxane) was PC-Si-2 and the loading was increased to 15 wt % corresponding to an amount effective to provide 4 wt % siloxane to the entire composition (see Comparative Example 14), delamination was observed. Therefore, in order to achieve a combination of chemical resistance and flame resistance with the desired aesthetics (i.e., no surface defects upon visual inspection).

This disclosure further encompasses the following aspects.

Aspect 1: A thermoplastic composition comprising: 70 to 98 wt % of a poly(carbonate-siloxane-arylate) and optionally a poly(carbonate-arylate); a poly(carbonate-siloxane) having 30-70 wt % siloxane content, based on the total weight of the poly(carbonate-siloxane) present in an amount effective to provide 0.5 to 10 wt % siloxane units based on the total weight of the composition; a flame retardant; optionally, 0.1 to 15 wt % of an antimicrobial agent, and optionally, 0.1 to 10 wt % of an additive composition, wherein each amount is based on the total weight of the poly(carbonate-siloxane-arylate), optional poly(carbonate-arylate), poly(carbonate-siloxane), flame retardant, optional antimicrobial agent, and optional additive composition, which does not exceed 100%.

Aspect 1a. The thermoplastic composition of Aspect 1, wherein the poly(carbonate-siloxane) having 30-70 wt % siloxane content is present in an amount effective to provide 0.5 to less than 4.0 wt % siloxane units based on the total weight of the composition.

Aspect 2: The thermoplastic composition of Aspect 1 or 1a, wherein a molded sample of the thermoplastic composition has: a 2-minute integrated heat release rate of less than or equal to 65 kW-min/m² and a peak heat release rate of less than 65 kW/m² as measured using the method according to Part IV, OSU Heat Release of FAR/JAR 25.853, Amendment 25-116; a notched Izod impact resistance of greater than 500 J/m measured on notched 3.2 mm bars at 23° C., in accordance with the ASTM-D256-10 (2018) standard; a yield tensile stress retention of at least 90% and an elongation at break retention of 80-139% according to the ISO527 standard after exposure to SANI-CLOTH AF3 for 24 hours at a temperature of 23° C. under 1% strain compared to a non-exposed reference sample of the same composition; a yield tensile stress retention of at least 90% and an elongation at break retention of 80-139% according to the ISO527 standard after exposure to a 50 wt % aqueous solution of HONEYBEE 90 for 20 hours at a temperature of 23° C. under 1% strain compared to a non-exposed reference sample of the same composition; or a combination thereof.

Aspect 2a. The thermoplastic composition of Aspect 1 or 2, wherein the molded sample have the siloxane content is less than 4 wt % has fewer surface defects as compared with a molded sample having the same composition, except that the total siloxane content is 4 wt % or greater.

Aspect 2b. The thermoplastic composition of Aspect 1 or 2, wherein the molded sample having the siloxane content is 3 wt % or less has fewer surface defects as compared with a molded sample having the same composition, except that the total siloxane content is 4 wt % or greater.

Aspect 3: The thermoplastic composition of Aspect 1, 1a, or 2, 2a, or 2b wherein the poly(carbonate-siloxane-arylate) comprises: bisphenol A carbonate units, resorcinol carbonate units, or a combination thereof, isophthalic acid-terephthalic acid-resorcinol ester units, and siloxane units.

Aspect 4: The thermoplastic composition of any one of the preceding aspects, wherein the poly(carbonate-siloxane-arylate) comprises: 0.2 to 10 wt % of siloxane units based on the total weight of the poly(carbonate-siloxane-arylate); 50 to 99.8 mol % arylate ester units, and less than 0.2 to 50 mol % aromatic carbonate units, each based on the sum of the moles of the siloxane units, the arylate ester units, and aromatic carbonate units in the poly(carbonate-siloxane-arylate); preferably wherein the arylate ester units are isophthalate-terephthalate-resorcinol ester units; the aromatic carbonate units are bisphenol A carbonate units, resorcinol carbonate units, or a combination thereof; and the siloxane units are polydimethylsiloxane units.

Aspect 5: The thermoplastic composition of any of the preceding aspects, wherein the poly(carbonate-arylate) comprises bisphenol A carbonate units, resorcinol carbonate units, isophthalic acid-terephthalic acid-resorcinol ester units, optionally, bisphenol A ester units, or a combination thereof, preferably bisphenol A carbonate units, resorcinol carbonate units, and isophthalic acid-terephthalic acid-resorcinol ester units.

Aspect 6: The thermoplastic composition of any of the preceding aspects, wherein the flame retardant comprises a brominated polycarbonate, an organophosphorous compound, or a combination thereof.

Aspect 7: The thermoplastic composition of any of the preceding aspects, wherein the flame retardant comprises an organophosphorous compound present in amount effective to provide 0.1 to 1.0 wt % phosphorous, based on the total weight of the composition.

Aspect 8: The thermoplastic composition of any of the preceding aspects, wherein the flame retardant comprises a phosphazene.

Aspect 9: The thermoplastic composition of any of the preceding aspects, wherein the flame retardant comprises the formula

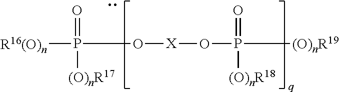

wherein R¹⁶, R¹⁷, R¹⁸ and R¹⁹ are each independently C₁₋₈ alkyl, C₅₋₆ cycloalkyl, C₆₋₂₀ aryl, or C₇₋₁₂ arylalkylene, each optionally substituted by C₁₋₁₂ alkyl, and X is a mono- or poly-nuclear aromatic C₆₋₃₀ moiety or a linear or branched C₂₋₃₀ aliphatic moiety, each of which may be OH-substituted and may contain up to 8 ether bonds, provided that at least one of R¹⁶, R¹⁷, R¹⁸, R¹⁹, and X is aromatic, n is each independently 0 or 1, and q is from 0.5 to 30; preferably wherein each of R¹⁶, R¹⁷, R¹⁸, and R¹⁹ is phenyl, X is of the formula

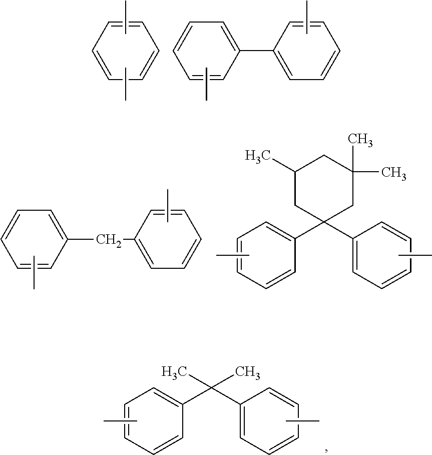

each n is 1, and q is 1-5.

Aspect 10: The thermoplastic composition of any of the preceding aspects, wherein the flame retardant comprises the formula

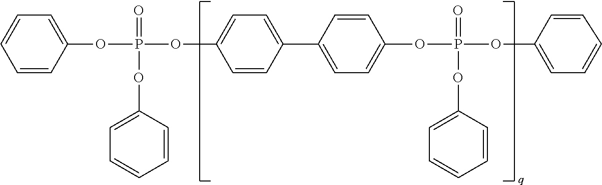

wherein m is 1 or 2, and q is 1 to 5.

Aspect 11: The thermoplastic composition of any of the preceding aspects, comprising 70 to 98 wt % of the poly(carbonate-siloxane-arylate) and optionally the poly(carbonate-arylate), the poly(carbonate-siloxane) having a siloxane content of 30 to 70 wt %, wherein the poly(carbonate-siloxane) is present in an amount effective to provide 0.5 to less than 4 wt % siloxane units, based on the total weight of the poly(carbonate-siloxane), and a brominated polycarbonate as the flame retardant, wherein the brominated polycarbonate is present in an amount effective to provide 2 to 20 wt % bromine, based on the total weight of the thermoplastic composition.

Aspect 11a. The thermoplastic composition of Aspect 11, wherein the poly(carbonate-siloxane) is present in an amount effective to provide 0.5 to 3.5 wt %, preferably 0.5-3.0 wt % siloxane units, based on the total composition.

Aspect 11b. The thermoplastic composition of Aspect 11 comprising 70 to 98 wt % of the poly(carbonate-siloxane-arylate) and the poly(carbonate-arylate), the poly(carbonate-siloxane) having a siloxane content of 30 to 70 wt %, wherein the poly(carbonate-siloxane) is present in an amount effective to provide 0.5 to less than 4 wt % siloxane units, based on the total weight of the poly(carbonate-siloxane), and a brominated polycarbonate as the flame retardant, wherein the brominated polycarbonate is present in an amount effective to provide 2 to 20 wt % bromine, based on the total weight of the thermoplastic composition.

Aspect 11c. The thermoplastic composition of Aspect 11, 11a, or 11b, wherein the weight ratio of poly(carbonate-siloxane-arylate) to the poly(carbonate-arylate) is greater than 1:1.

Aspect 11d. The thermoplastic composition of Aspect 11, 11a, or 11b, wherein the weight ratio of poly(carbonate-siloxane-arylate) to the poly(carbonate-arylate) is less than 1:1.

Aspect 12: The thermoplastic composition of any of the preceding aspects, comprising 70 to 98 wt % of the poly(carbonate-siloxane-arylate) and optionally the poly(carbonate-arylate), the poly(carbonate-siloxane) having a siloxane content of 30 to 70 wt %, wherein the poly(carbonate-siloxane) is present in an amount effective to provide 0.5 to less than 4 wt % siloxane units, based on the total weight of the poly(carbonate-siloxane), an organophosphorous compound as the flame retardant, wherein the organophosphorous compound is present in an amount effective to provide 0.1 to 1.0 wt % phosphorous, based on the total weight of the thermoplastic composition.

Aspect 13: An article comprising the composition of any of the preceding aspects comprising a molded article, a thermoformed article, an extruded film, an extruded sheet, a foamed article, a layer of a multi-layer article, a substrate for a coated article, and a substrate for a metallized article, preferably wherein the article is an aircraft interior component.

Aspect 14: The article of Aspect 13, wherein the aircraft component is a profile, panel, panel insert, air flow regulator, call button, oxygen system housing, oxygen system cover, window frame, window housing, lighting rail, grip rail, passenger service unit component, luggage bin component, profile, washing table, side wall component, food tray, in-flight entertainment housing, display bezel, crew communication device component, seat component, side-arm panel, literature pocket, tray table, monitor cover, kick panel, tray table arm, foot rests seat arm, headrest, electronic housing, air ducting component, grill, panel fixation, cable bracket, door handle, hinge, or trolley component or connector

Aspect 15: A method of manufacture of an article, comprising molding, extruding, additively manufacturing, or casting the composition of any one of aspects 1 to 12 to form the article.

The compositions, methods, and articles may alternatively comprise, consist of, or consist essentially of, any appropriate materials, steps, or components herein disclosed. The compositions, methods, and articles may additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

The term “alkyl” means a branched or straight chain, unsaturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo groups (e.g., bromo and fluoro), or only chloro groups may be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that may each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl) a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A thermoplastic composition comprising:
70 to 98 wt % of a poly(carbonate-siloxane-arylate) and optionally a poly(carbonate-arylate);
a poly(carbonate-siloxane) having 30-70 wt % siloxane content, based on the total weight of the poly(carbonate-siloxane) present in an amount effective to provide 0.5 to 10 wt % siloxane units based on the total weight of the composition;
a flame retardant; and
optionally, 0.1 to 10 wt % of an additive composition,
optionally, 0.1 to 15 wt % of an antimicrobial agent,
wherein each amount is based on the total weight of the poly(carbonate-siloxane-arylate), optional poly(carbonate-arylate), poly(carbonate-siloxane), flame retardant, and optional additive composition, which does not exceed 100%.

2. The thermoplastic composition of claim 1, wherein a molded sample of the thermoplastic composition has:
a 2-minute integrated heat release rate of less than or equal to 65 kW-min/m² and a peak heat release rate of less than 65 kW/m² as measured using the method according to Part IV, OSU Heat Release of FAR/JAR 25.853, Amendment 25-116;
a notched Izod impact resistance of greater than 500 J/m measured on notched 3.2 mm bars at 23° C., in accordance with the ASTM-D256-10 (2018) standard;
a yield tensile stress retention of at least 90% and an elongation at break retention of 80-139% according to the ISO527 standard after exposure to SANI-CLOTH AF3 for 24 hours at a temperature of 23° C. under 1% strain compared to a non-exposed reference sample of the same composition;
a yield tensile stress retention of at least 90% and an elongation at break retention of 80-139% according to the ISO527 standard after exposure to a 50 wt % aqueous solution of HONEYBEE 90 for 20 hours at a temperature of 23° C. under 1% strain compared to a non-exposed reference sample of the same composition;
or a combination thereof.

3. The thermoplastic composition of claim 1, wherein the poly(carbonate-siloxane-arylate) comprises: bisphenol A carbonate units, resorcinol carbonate units, or a combination thereof, isophthalic acid-terephthalic acid-resorcinol ester units, or a combination thereof, and siloxane units.

4. The thermoplastic composition of claim 1, wherein the poly(carbonate-siloxane-arylate) comprises:
0.2 to 10 wt % of siloxane units based on the total weight of the poly(carbonate-siloxane-arylate);
50 to 99.8 mol % arylate ester units, and
0.2 to 49.8 mol % aromatic carbonate units, each based on the sum of the moles of the siloxane units, the arylate ester units, and carbonate units in the poly(carbonate-siloxane-arylate).

5. The thermoplastic composition of claim 1, wherein the poly(carbonate-arylate) comprises bisphenol A carbonate units, resorcinol carbonate units, isophthalic acid-terephthalic acid-resorcinol ester units, optionally, bisphenol A ester units, or a combination thereof.

6. The thermoplastic composition of claim 1, wherein the flame retardant comprises a brominated polycarbonate, an organophosphorous compound, or a combination thereof.

7. The thermoplastic composition of claim 1, wherein the flame retardant comprises an organophosphorous compound present in amount effective to provide 0.1 to 1.0 wt % phosphorous, based on the total weight of the composition.

8. The thermoplastic composition of claim 1, wherein the flame retardant comprises a phosphazene.

9. The thermoplastic composition of claim 1, wherein the flame retardant comprises the formula 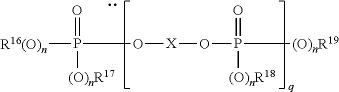
wherein
R¹⁶, R¹⁷, R¹⁸ and R¹⁹ are each independently C₁₋₈ alkyl, C₅₋₆ cycloalkyl, C₆₋₂₀ aryl, or C₇₋₁₂ arylalkylene, each optionally substituted by C₁₋₁₂ alkyl, and
X is a mono- or poly-nuclear aromatic C₆₋₃₀ moiety or a linear or branched C₂₋₃₀ aliphatic moiety, each of which may be OH-substituted and may contain up to 8 ether bonds, provided that at least one of R¹⁶, R¹⁷, R¹⁸, R¹⁹, and X is aromatic,
n is each independently 0 or 1, and
q is from 0.5 to 30.

10. The thermoplastic composition of claim 1, wherein the flame retardant comprises the formula 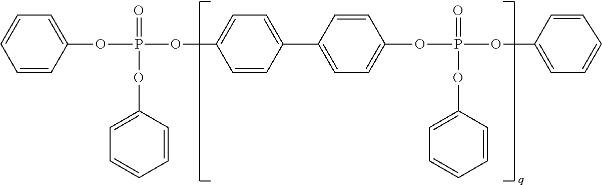
wherein m is 1 or 2, and q is 1 to 5.

11. The thermoplastic composition of claim 1, comprising
70 to 98 wt % of the poly(carbonate-siloxane-arylate) and optionally the poly(carbonate-arylate),
the poly(carbonate-siloxane) having a siloxane content of 30 to 70 wt %, wherein the poly(carbonate-siloxane) is present in an amount effective to provide 0.5 to less than 4 wt % siloxane units, based on the total weight of the poly(carbonate-siloxane), and
a brominated polycarbonate as the flame retardant, wherein the brominated polycarbonate is present in an amount effective to provide 2 to 20 wt % bromine, based on the total weight of the thermoplastic composition.

12. The thermoplastic composition of claim 1, comprising
70 to 98 wt % of the poly(carbonate-siloxane-arylate) and optionally the poly(carbonate-arylate),
the poly(carbonate-siloxane) having a siloxane content of 30 to 70 wt %, wherein the poly(carbonate-siloxane) is present in an amount effective to provide 0.5 to 10 wt % siloxane units, based on the total weight of the poly(carbonate-siloxane),
an organophosphorous compound as the flame retardant, wherein the organophosphorous compound is present in an amount effective to provide 0.1 to 1.0 wt % phosphorous, based on the total weight of the thermoplastic composition.

13. An article comprising the composition of claim 1 comprising a molded article, a thermoformed article, an extruded film, an extruded sheet, a foamed article, a layer of a multi-layer article, a substrate for a coated article, and a substrate for a metallized article.

14. The article of claim 13, wherein the article is an aircraft interior component, and wherein the aircraft component is a profile, panel, panel insert, air flow regulator, call button, oxygen system housing, oxygen system cover, window frame, window housing, lighting rail, grip rail, passenger service unit component, luggage bin component, profile, washing table, side wall component, food tray, in-flight entertainment housing, display bezel, crew communication device component, seat component, side-arm panel, literature pocket, tray table, monitor cover, kick panel, tray table arm, foot rests seat arm, headrest, electronic housing, air ducting component, grill, panel fixation, cable bracket, door handle, hinge, or trolley component or connector.

15. A method of manufacture of an article, comprising molding, extruding, additively manufacturing, or casting the composition of any one of claims 1 to 12 to form the article.

16. The thermoplastic composition of claim 1, wherein the poly(carbonate-arylate) comprises bisphenol A carbonate units, resorcinol carbonate units, and isophthalic acid-terephthalic acid-resorcinol ester units.

17. The thermoplastic composition of claim 1, wherein the arylate ester units are isophthalate-terephthalate-resorcinol ester units; the aromatic carbonate units are bisphenol A carbonate units, resorcinol carbonate units, or a combination thereof; and the siloxane units are polydimethylsiloxane units.
